(19) United States
(12) Patent Application Publication
(10) Pub. No.: US 2025/0298866 A1
(43) Pub. Date: Sep. 25, 2025

(54) DATA PROCESSING METHOD AND DATA PROCESSING DEVICE

(71) Applicant: Proterial, Ltd., Tokyo (JP)

(72) Inventors: Daisuke SHANAI, Tokyo (JP); Tomonori WATANABE, Tokyo (JP); Takehiko TANI, Tokyo (JP); Tamotsu KIBE, Tokyo (JP)

(21) Appl. No.: 19/046,178

(22) Filed: Feb. 5, 2025

(30) Foreign Application Priority Data
Mar. 25, 2024 (JP) 2024-047718

(51) Int. Cl. G06F 17/18; G06N 20/00

(52) U.S. Cl. CPC G06F 17/18; G06N 20/00

(57) ABSTRACT

A data processing method for data processing of training data includes a plurality of data including an explanatory variable and an objective variable is provided. The data processing method includes detecting an outlier from the training data, creating a first training data by excluding the outlier detected in the outlier detection step from the training data, creating a first regression model using the first training data as teaching data, and using the first regression model to obtain a first predicted value, which is a predicted value of the objective variable corresponding to a value of the explanatory variable of the excluded outlier, and substituting the excluded outlier with a value based on the first predicted value from the training data to create outlier-substituted training data.

### CROSS-REFERENCE TO RELATED APPLICATIONS

The present patent application claims the priority of Japanese patent application No. 2024-47718 filed on Mar. 25, 2024, the entire contents of which are incorporated herein by reference.

### TECHNICAL FIELD

The present disclosure relates to a data processing method and an data processing device in machine learning.

### BACKGROUND OF THE INVENTION

Methods for making various predictions using machine learning are known. For example, in case of predicting the physical properties of a material with unknown mixing proportion, machine learning is performed using data already obtained through trial manufacturing, etc., as training data (or, teaching data, teacher data, supervised data) to learn the correlation between the mixing proportions of the materials and the physical properties, and prediction is made using a regression model obtained as a result of the learning.

Here, if the training data includes outliers, which are erroneous data or data with large errors, the prediction accuracy of the regression model obtained using the training data will be reduced. Therefore, prior to machine learning, outliers are removed from the training data (see, e.g., Patent Literature 1).

### CITATION LIST

Patent Literature 1: JP2021-33544A

### SUMMARY OF THE INVENTION

However, removing outliers from the training data reduces the number of data in the training data. As a result, the range of values that can be accurately predicted by a regression model created using the training model becomes narrower.

Therefore, the object of the present invention is to provide a data processing method and a data processing device that can suppress the narrowing of the predictable numerical range while improving prediction accuracy.

To solve the problems described above, one aspect of the present invention provides a data processing method for data processing of training data including a plurality of data comprising an explanatory variable and an objective variable, comprising:
an outlier detection step of detecting an outlier from the training data;
a predicted value calculation step of creating a first training data by excluding the outlier detected in the outlier detection step from the training data, creating a first regression model using the first training data as teaching data, and using the first regression model to obtain a first predicted value, which is a predicted value of the objective variable corresponding to a value of the explanatory variable of the excluded outlier; and
a data substitution step of substituting the excluded outlier with a value based on the first predicted value from the training data to create outlier-substituted training data.

To solve the problems described above, another aspect of the present invention provides a data processing device for data processing of training data including a plurality of data comprising an explanatory variable and an objective variable, comprising:
an outlier detection processing unit for detecting an outlier from the training data;
a predicted value calculation processing unit for creating a first training data by excluding the outlier detected by the outlier detection processing unit from the training data, creating a first regression model using the first training data as teaching data, and using the first regression model to obtain a first predicted value, which is a predicted value of the objective variable corresponding to a value of the explanatory variable of the excluded outlier; and
a data substitution processing unit for substituting the excluded outlier with a value based on the first predicted value from the training data to create outlier-substituted training data.

### Advantageous Effects of the Invention

According to the invention, it is possible to provide a data processing method and a data processing device that can suppress the narrowing of the predictable numerical range while improving prediction accuracy.

### BRIEF DESCRIPTION OF DRAWINGS

FIG. 1 is a schematic configuration diagram illustrating a data processing device in an embodiment of the present invention.

FIG. 2 is a diagram showing an example of training data.

FIG. 3A is a diagram showing an example of calculation results of a variation coefficient.

FIG. 3B is a histogram of the calculation results in FIG. 3A.

FIG. 4 is an explanatory diagram showing teaching data used in the outlier determination processing.

FIG. 5 is a diagram showing the calculation results of an error rate for each of the outlier candidate data obtained in FIG. 3A.

FIG. 6 is an explanatory diagram showing a first training data.

FIG. 7A is a flow chart of the data processing method in an embodiment of the present invention.

FIG. 7B is a flow chart of its outlier detection processing.

FIG. 8 is a flow chart of a data classification processing.

FIG. 9 is a flow chart of an outlier determination processing.

FIG. 10 is a flow chart of a predicted value calculation processing.

FIG. 11 is a flow chart of a data substitution processing.

FIG. 12 is a flow chart of a prediction processing.

FIG. 13 is an explanatory diagram for explaining the first training data in a modified example of the invention.

FIG. 14 is a flow chart of the predicted value calculation processing in a modified example of the invention.

FIG. 15 is a graph showing the calculation results of MAPE in Examples and comparative examples.

### DETAILED DESCRIPTION OF THE INVENTION

### Embodiments

Embodiments of the invention will be described below in conjunction with the appended drawings.

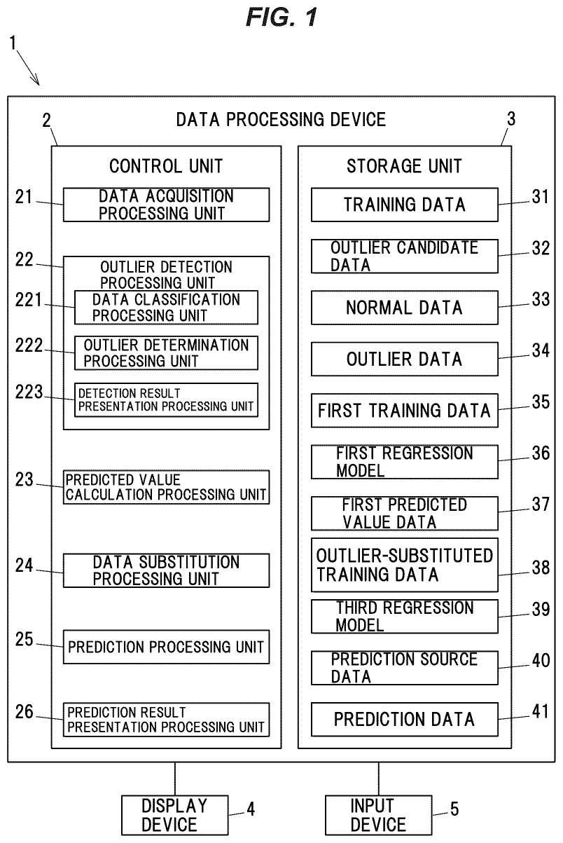

FIG. 1 is a schematic configuration diagram illustrating a data processing device 1 in the present embodiment. The data processing device 1 has a function of detecting outliers from training data 31 used for machine learning and substituting (i.e., replacing) values of the objective variables of the detected outliers with predicted values. The data processing device 1 also has a function to make predictions using a regression model 39 created using the training data obtained by substituting outliers with predicted values (outlier-substituted training data 38 described below). An outlier is a value that deviates significantly from other data due to, for example, measurement error, human error such as instrument misreading or input error, or the effect of noise.

The data processing device 1 has a control unit 2 and a storage unit 3. The data processing device 1 is, e.g., a computer such as personal computer or server device, and includes an arithmetic element such as a CPU, a memory such as RAM or ROM, a storage device such as hard disk, and a communication interface that is a communication device such as LAN card.

The control unit 2 has a data acquisition processing unit 21, an outlier detection processing unit 22, a predicted value calculation processing unit 23, a data substitution processing unit 24, a prediction processing unit 25, and a prediction result presentation processing unit 26. Details of each unit will be described later. The storage unit 3 is realized by a predetermined storage area of a memory or storage device.

The data processing device 1 also has a display unit 4 and an input device 5. The display unit 4 is, e.g., a liquid crystal display, and the input device 5 is, e.g., a keyboard and a mouse, etc. The display unit 4 may be configured as a touch panel, and the display unit 4 may also serve as the input device 5. In addition, the display unit 4 and the input device 5 may be configured separately from the data processing device 1 and be capable of communicating with the data processing device 1 by wireless communication, etc. In this case, the display unit 4 or input device 5 may be composed of a portable terminal such as a tablet or smartphone.

### Data Acquisition Processing Unit 21

The data acquisition processing unit 21 performs data acquisition processing to acquire the training data 31 from an external device. In the data acquisition processing, for example, the training data 31 is acquired via a network from, for example, a server device that stores data on manufacturing results, and the acquired data is stored in the storage unit 3 as the training data 31. The training data 31 may be input to the data processing device 1 via media such as USB memory, for example, and the method of acquiring the training data 31 is not particularly limited.

### Training Data 31

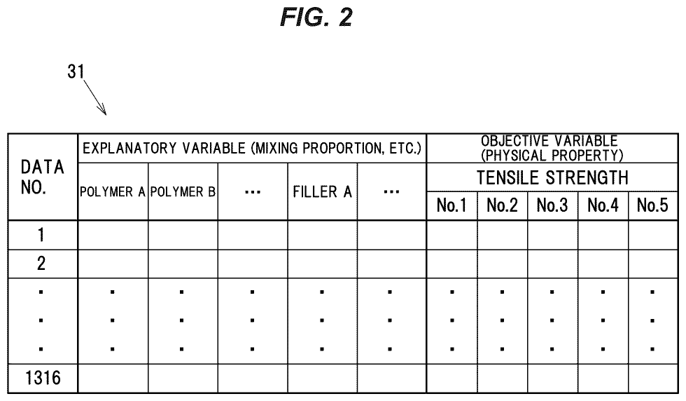

Here, the training data 31 will be described. FIG. 2 is a diagram illustrating an example of the training data 31. The training data 31 is a database used as teacher data when performing machine learning, and includes data of explanatory and objective variables used in machine learning. FIG. 2 shows an example in which the mixing amounts of materials such as polymers and fillers, etc., are used as explanatory variables, and the physical property (tensile strength in this example) of a composite material produced using said materials is used as an objective variable. Performing machine learning using this training data 31 and creating a regression model representing a correlation between the explanatory variable (the mixing amount of each material) and the objective variable (the physical property) allows for prediction of the physical property of a composite material when manufactured with unknown mixing proportions of materials.

In the present embodiment, each data included in the training data 31 included multiple values of the objective variable. Here, each data includes five values of the objective variable (in the illustrated example, the tensile strength value). The values of these objective variables are obtained, for example, by manufacturing composite materials using the same formulation to form multiple samples (in this case, five samples of No. 1 to No. 5) and measuring the properties of each sample, such as tensile strength. Here, we will discuss the case where the training data 31 includes 1316 data in the initial state.

### Outlier Detection Processing Unit 22

The outlier detection processing unit 22 performs an outlier detection processing to detect outliers from a plurality of data included in the training data 31. The outlier detection processing corresponds to the outlier detection step of the present invention. The outlier detection processing unit 22 has a data classification processing unit 221, an outlier determination processing unit 222, and a detection result presentation processing unit 223. The specific processing details of the outlier detection processing described below are only an example, and outliers may be detected by other methods. In other words, the specific method for detecting outliers can be selected as appropriate and is not limited to the method described below.

### Data Classification Processing Unit 221

The data classification processing unit 221 performs a data classification processing to pick up data that are candidates for outliers from the training data 31. The data classification processing corresponds to the data classification step of the present invention.

In the data classification processing, the variation coefficient of the value of the objective variable is first obtained for each of the data included in the training data 31. The variation coefficient can be obtained using the following formula (1).

(Variation coefficient)={(Standard deviation)/(Mean)}×100 (1)

Of the data included in the training data 31, the data for which the calculated variation coefficient is larger than the preset reference value are classified as outlier candidate data 32, and the other data are classified as normal data 33, and stored in the storage unit 3. A large value of the variation coefficient means a large variation in the value of the objective variable, which is considered to increase the possibility of including outliers. Here, the outlier candidate data 32 and the normal data 33 are stored in the storage unit 3 as separate data from the training data 31, but this is not limited to this. For example, each data in the training data 31 may be marked with a flag or marker so that the outlier candidate data 32 and the normal data 33 can be distinguished from each other. In other words, a portion of the training data 31 may be used as the outlier candidate data 32 or the normal data 33.

The reference value of the variation coefficient for determining an outlier candidate can be set appropriately. For example, this reference value can be set in consideration of a target objective variable and the variability of the data as a whole, and can be the mean, median, mode, mean ±σ (σ is standard deviation), mean ±2σ, mean ±3σ, etc. of the variation coefficient of all data included in the training data 31. Here, the variation coefficients of representative blending data considering manufacturing results, etc., among the data included in the training data 31 are used as reference values.

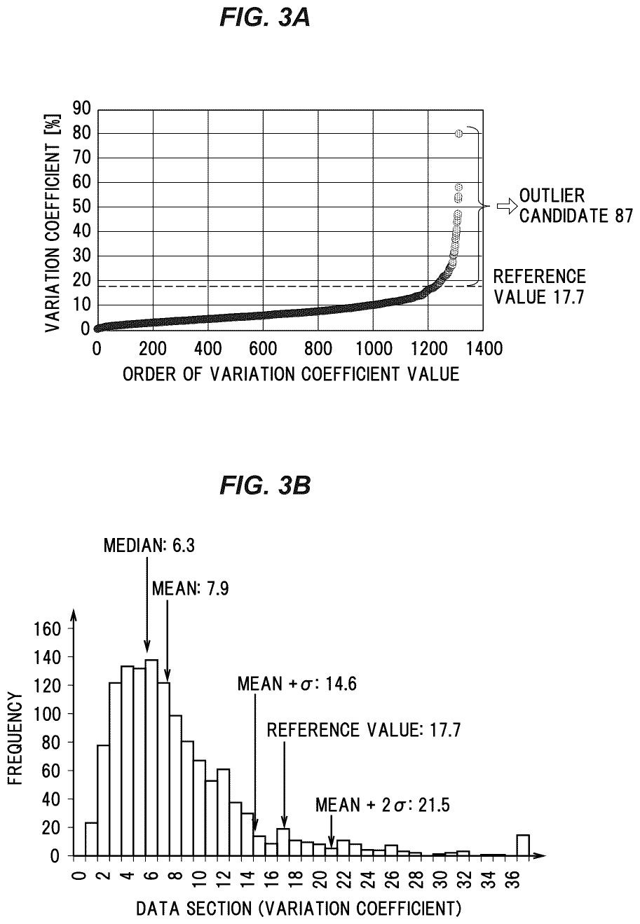

FIG. 3A is a diagram showing an example of the calculation results of the variation coefficient. In FIG. 3A, the variation coefficient was calculated for 1316 data points and plotted in order of decreasing value. In the illustrated example, the variation coefficient in a representative formula was used and the reference value was set at 17.7. As shown in FIG. 3A, in the illustrated example, there were 87 data points that exceeded the reference value. In the data classification processing, these 87 data would be considered outlier candidate data 32 and the remaining 1229 data would be considered normal data 33.

FIG. 3B is a diagram showing the calculation results of the variation coefficient in FIG. 3A as a histogram. FIG. 3B also shows the mean, median, mean +σ, mean +2σ, and mean +3σ values of the variation coefficient for all data in the training data 31. As shown in FIG. 3B, the value of 17.7 used as the reference value this time was larger than the mean value +σ and smaller than the mean value +2σ.

### Outlier Determination Processing Unit 222

The outlier determination processing unit 222 performs an outlier determination processing to determine whether each data included in the outlier candidate data 32 picked up in the data classification processing is an outlier. The outlier determination processing corresponds to the outlier determination step of the present invention.

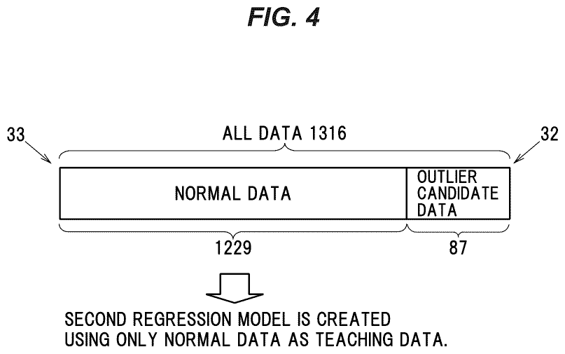

As shown in FIG. 4, in the outlier determination processing, a second regression model (regression model for outlier determination), which is a regression model showing the correlation between explanatory variables and objective variables, is created using the normal data 33 (1229 data) as teaching data. Although each data in the present embodiment includes the values of multiple objective variables, the median of the values of multiple objective variables is used here for learning. For each of the outlier candidate data 32 (87 data), the second predicted value, which is the predicted value, is calculated using the created second regression model, and the error rate between the obtained second predicted value and the actual objective variable value (actual value) is calculated. Although each data includes the values of multiple objective variables, the median of the values of multiple objective variables is used here as the actual value. The error rate is calculated by the following formula.

(Error rate)=100×{(Predicted value)−(Actual value)}/(Predicted value)

The outlier determination processing unit 222 determines whether the data is an outlier based on the error rate obtained by calculation. The outlier determination processing unit 222 determines whether each of the outlier candidate data 32 is an outlier based on the error rate obtained by the calculation. In the present embodiment, the data is determined to be an outlier when the absolute value of the calculated error rate is greater than or equal to a preset threshold value.

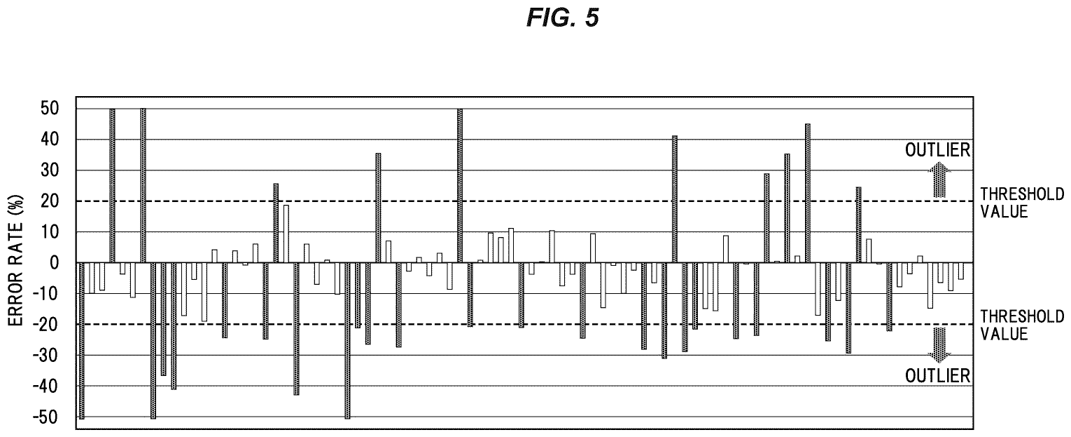

FIG. 5 is a diagram showing the calculation results of the error rate for each of the 87 candidate outlier data 32 obtained in FIG. 3A. In the illustrated example, the threshold value is set at 20%, but the threshold value can be set as desired. In this case, the data is determined to be an outlier when the error rate obtained is +20% or more or −20% or less. In the example in FIG. 5, thirty-three (33) data of eighty-seven (87) outlier candidate data 32 were determined to be outliers. The data determined as outliers are stored in the storage unit 3 as outlier data 34.

### Detection Result Presentation Processing Unit 223

The detection result presentation processing unit 223 performs detection result presentation processing to present the determination result of the outlier determination processing, i.e., the detection result of the outlier. In the detection result presentation processing, the data detected as an outlier (outlier data 34) is displayed on the display unit 4, etc., to present the data to the user. The detection result presentation processing unit 223 is not essential and can be omitted.

### Predicted Value Calculation Processing Unit 23

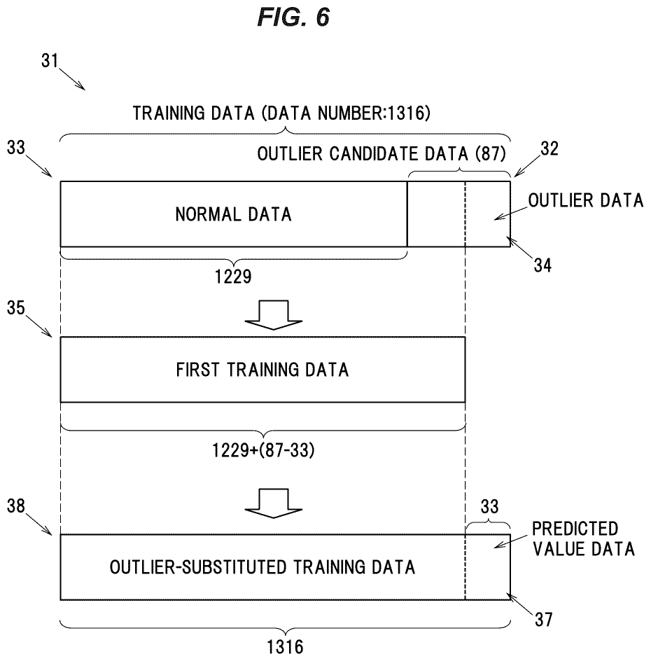

The predicted value calculation processing unit 23 performs predicted value calculation processing to obtain the predicted value of the value of the target variable (first predicted value) for each of the outliers detected in the outlier detection processing. The predicted value calculation processing corresponds to the predicted value calculation step of the present invention. More specifically, as shown in FIG. 6, the predicted value calculation processing unit 23 first creates first training data 35 (training data for predicted value calculation) by excluding the outlier data 34, which is the data of outliers detected in the outlier detection processing, from the training data 31. In this embodiment, the first training data 35 (number of data: 1283(=1229+(87−33))) is created by excluding all outlier data 34 from the training data 31. Then, using the first training data 35 as teaching data, a first regression model 36 is created, which is a regression model showing the correlation between the explanatory variables and the objective variable. The created first regression model 36 is stored in the storage unit 3.

The predicted value calculation processing unit 23 then uses the created first regression model 36 to obtain, for each of the outlier data 34 (33 data), the first predicted value, which is the predicted value of the objective variable corresponding to the value of the explanatory variable included in that data. The first predicted value corresponding to each outlier obtained in the predicted value calculation processing is stored in the storage unit 3 as predicted value data 37 (33 data).

### Data Substitution Processing Unit 24

The data substitution processing unit 24 performs data substitution processing to create outlier-substituted training data 38 by substituting the value of the objective variable for each outlier in the training data 31 (outliers excluded from the training data 31 in the predicted value calculation process) with a value based on the first predicted value obtained in the predicted value calculation processing. In the present embodiment, the values of the outlier objective variables were substituted with the first predicted values. The data substitution processing corresponds to the data substitution step of the present invention. The data substitution processing unit 24 stores the created outlier-substituted training data 38 (1316 data, see FIG. 6) in the storage unit 3.

### Prediction Processing Unit 25

The prediction processing unit 25 performs a prediction processing to predict the value of the target objective variable (third predicted value) using the outlier-substituted training data 38 obtained by the data substitution processing unit 24. The prediction processing corresponds to the prediction step of the present invention. In the prediction processing, first, using the outlier-substituted training data 38 as teaching data, a third regression model 39 (regression model for predicting properties, etc.) is created, which is a regression model showing the correlation between the explanatory variables and the target variables. For data including multiple values of the objective variable, the median of the multiple values of the objective variable is used for learning. The created third regression model 39 is stored in the storage unit 3. The created third regression model 39 is then used to predict the third predicted value, which is the predicted value of the objective variable corresponding to the value of the explanatory variable to be predicted. For example, in the example in FIG. 2, the objective variable is tensile strength (physical property).

In more detail, a prediction source data 40, which are the values of each explanatory variable entered by the input device 5, etc., are applied to the third regression model 39 to obtain a third predicted value, which is the value of the corresponding objective variable. The obtained third predicted value is stored in the storage unit 3 as predicted data 41.

### Prediction Result Presentation Processing Unit 26

The prediction result presentation processing unit 26 performs prediction result presentation processing to present the prediction results from the prediction processing. In the prediction result presentation processing, for example, forty-one (41) prediction data obtained in the prediction processing is displayed on the display unit 4.

### Data Processing Method

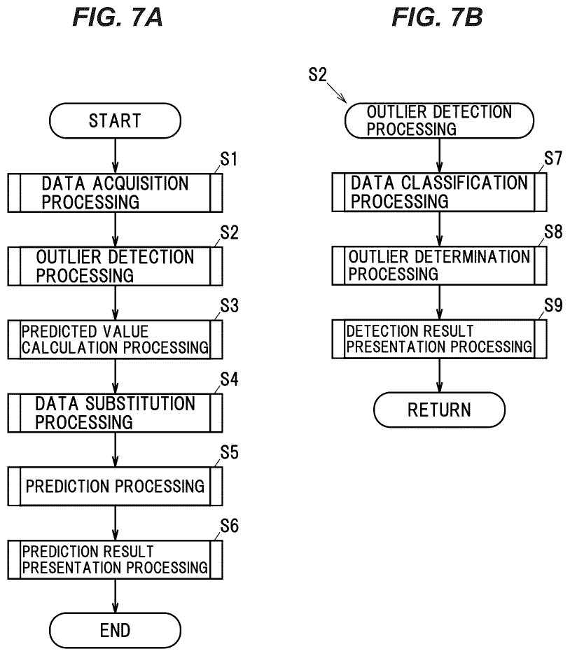

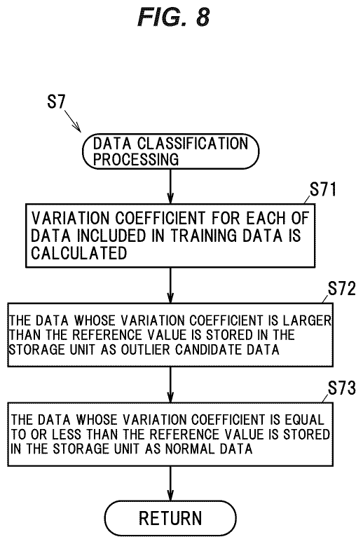

FIG. 7A is a flow chart of the data processing method. As shown in FIG. 7A, first, data acquisition processing is performed in step S1. In the data acquisition processing, the data acquisition processing unit 21 acquires the training data 31 (in the case of FIG. 6, the number of data is 1316) from an external device or other source. The acquired training data 31 are stored in the storage unit 3.

Then, in step S2, the outlier detection processing is performed. In the outlier detection processing, as shown in FIG. 7B, the data classification processing is first performed in step S7. In the data classification processing, as shown in FIG. 8, first, in step S71, the variation coefficient for each of the data included in the training data 31 is calculated. Then, in step S72, the data whose variation coefficient is larger than the preset reference value are stored in the storage unit 3 as the outlier candidate data 32 (87 data in the case of FIG. 6). Then, in step S73, the data whose variation coefficient is less than or equal to the reference value are stored in the storage unit 3 as the normal data 33 (in the case of FIG. 6, the number of data is 1229). After that, it returns and proceeds to step S8 in FIG. 7B.

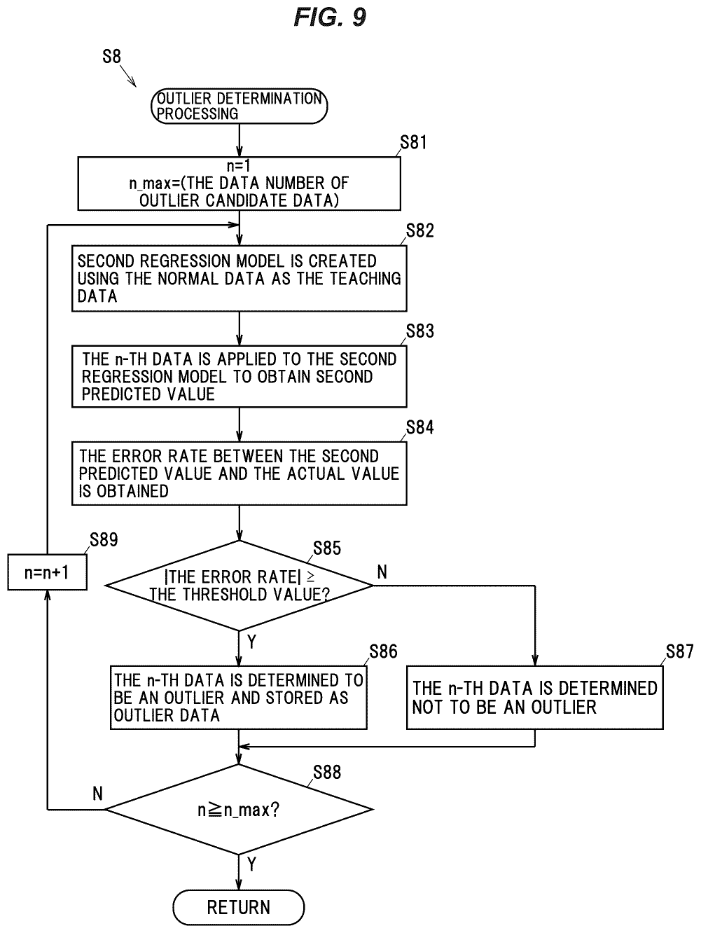

In step S8, the outlier determination processing is performed. In the outlier determination processing, as shown in FIG. 9, first, in step S81, 1 is assigned as the initial value to n, a variable representing the data number, and the number of data of the outlier candidate data 32 is assigned to n_max. Then, in step S82, the second regression model is created using the normal data 33 as the teaching data. Then, in step S83, the value of the explanatory variable of the n-th data among the outlier candidate data 32 is applied to the second regression model to obtain the second predicted value (value of the objective variable), and in step S84, the error rate between the second predicted value and the actual value (value of the objective variable of the n-th data) is obtained. Then, in step S85, it is determined whether the absolute value of the error rate obtained is greater than or equal to the preset threshold value. If YES (Y) is determined in step S85, the data of number n is determined to be an outlier in step S86, stored in the storage unit 3 as the outlier data 34 (in the case of FIG. 6, the number of data is 33), and proceeds to step S88. If NO (N) is determined in step S85, in step S87, the data of number n is determined not to be an outlier, and then proceeds to step S88. In step S88, it is determined whether the variable n is greater than or equal to n_max. If NO (N) is determined in step S88, the variable n is incremented in step S89 and then returns to step S82. If YES (Y) is determined in step S88, returns and proceeds to step S9 in FIG. 7B.

In step S9, the detection result presentation processing is performed. In the detection result presentation processing, the detected outlier is presented by displaying the data that was determined to be an outlier in step S8, i.e., the outlier data 34, on the display unit 4 or by other means. It then returns and proceeds to step S3 in FIG. 7A.

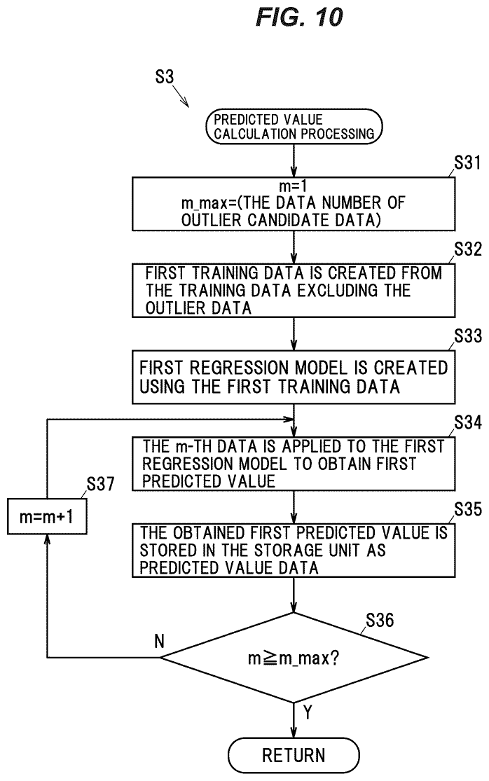

In step S3, the predicted value calculation processing is performed. In the predicted value calculation processing, as shown in FIG. 10, first, in step S31, 1 is assigned as the initial value to m, a variable representing the data number, and the number of data in the outlier data 34 is assigned to m_max. Then, in step S32, the predicted value calculation processing unit 23 creates the first training data 35 (in the case of FIG. 6, the number of data is 1283 (=1229+(87−33))), excluding outliers (the outlier data 34) from the training data 31, and in step S33, the first training data 35 is used as teaching data. In step S33, the first regression model 36 is created using the first training data 35 as the teaching data. Then, in step S34, the first predicted value (value of the objective variable) is obtained by applying the value of the explanatory variable of the m-th data in the outlier data 34 to the first regression model 36, and in step S35, the obtained first predicted value is stored in the storage unit 3 as the predicted value data 37 (the number of data is 33 in the case of FIG. 6). Then, in step S36, it is determined whether the variable m is greater than or equal to m_max. If NO (N) is determined in step S36, the variable m is incremented in step S37 and then returns to step S34. If YES (Y) is determined in step S36, it returns and proceeds to step S4 in FIG. 7A.

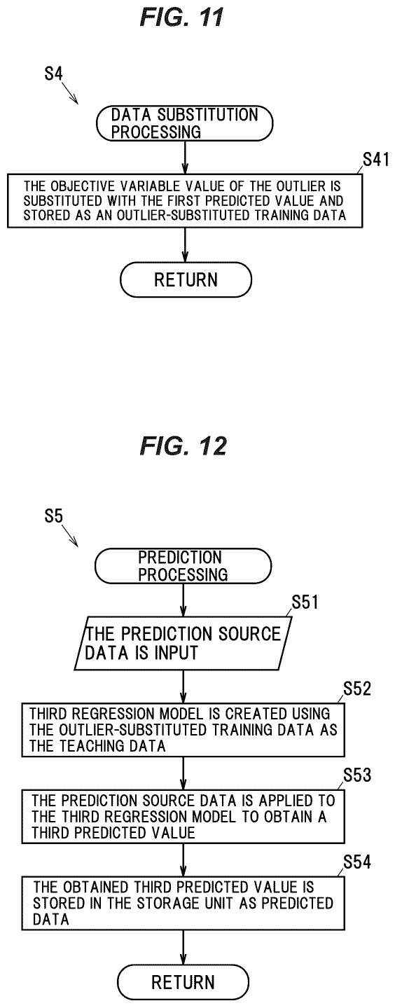

In step S4, the data substitution processing is performed. In the data substitution processing, as shown in FIG. 11, in step S41, the value of the objective variable of the outlier (the outlier data 34) is substituted with the first predicted value (the predicted data 37) in the training data 31 to create the outlier-substituted training data 38 (the number of data is 1316 in the case of FIG. 6), which is stored in the storage unit 3. It then returns and proceeds to step S5 in FIG. 7A.

In step S5, the prediction processing is performed. In the prediction processing, as shown in FIG. 12, first, in step S51, the prediction source data 40 is input using the input device 5 or the like. The inputted prediction source data 40 is stored in the storage unit 3. Then, in step S52, the third regression model 39 is created using the outlier-substituted training data 38 as the teaching data, and stored in the storage unit 3. Then, in step S53, the prediction source data 40 is applied to the third regression model 39 to obtain the third predicted value (value of the objective variable), and in step S54, the obtained third predicted value is stored in the storage unit 3 as the predicted data 41. Thereafter, it returns and proceeds to step S6 in FIG. 7A.

In step S6, the prediction result presentation processing is performed. In the prediction result presentation processing, the prediction results of the prediction processing (the predicted data 41) are displayed on the display unit 4. The prediction source data 40 corresponding to the predicted data 41 may also be displayed on the display unit 4, and so on. The processing is then terminated.

### MODIFIED EXAMPLES

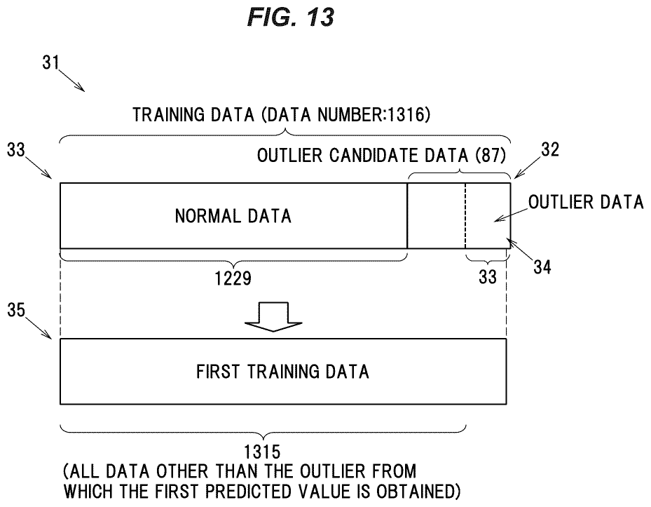

In the preset embodiment, the first predicted value was obtained in the predicted value calculation processing using the first training data 35 as the data from which all the outlier data 34 were removed from the training data 31. However, as shown in FIG. 13, the invention is not limited to this. In other words, all data other than the outlier for which the first predicted value is obtained may be included in the first training data 35 (in the case of FIG. 13, the number of data is 1315). In this case, the first regression model 36 (in the case of FIG. 13, the number of created regression models 36 for calculating the predicted values is 33) is created for each outlier separately.

In other words, in the predicted value calculation processing, for each of the outliers detected in the outlier detection processing, the first regression model 36 may be created using the first training data 35, from which the data of the target outlier (in this modified example, only the data of the target outlier) is excluded from the training data 31, as teaching data. The created first regression model 36 may then be used to obtain the first predicted value, which is the predicted value of the objective variable corresponding to the value of the explanatory variable of the data of the target outlier.

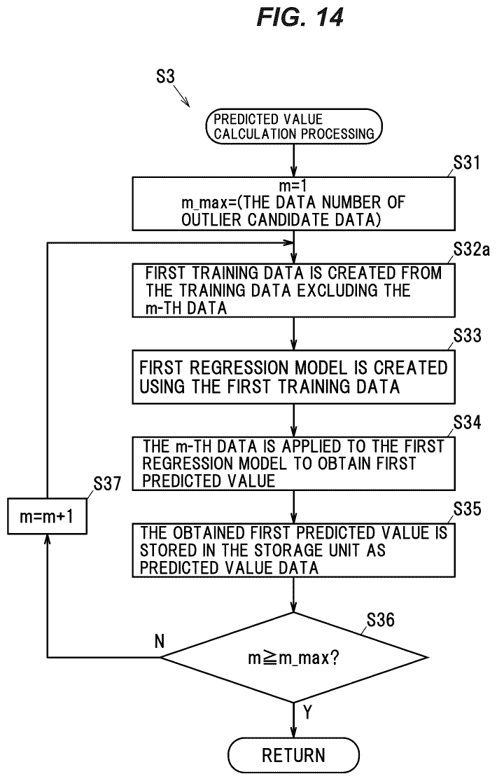

The control flow of the predicted value calculation processing in this case is shown in FIG. 14. In the control flow shown in FIG. 14, step S32 is replaced with step S32a in FIG. 10 and the return destination from step S37 is changed to step S32a; otherwise, the contents are the same as in FIG. 10. As shown in FIG. 14, in step S32a, the first training data 35 is created from the training data 31, excluding only the m-th data of the outlier data 34.

In the data substitution processing, the value of the objective variable of the outlier is simply substituted with the first predicted value. However, the invention is not limited to this, and the value of the objective variable of the outlier may be substituted with the value based on the first predicted value. For example, the value of the objective variable of the outlier may be substituted with the mean the value of the objective variable of the outlier (e.g., median if there are multiple values) and the first predicted value.

The improvement of the prediction accuracy in the present embodiment The prediction accuracy when using this data processing method was calculated. Outlier detection was performed using the training data 31 with 1197 data. In Example 1, the first predicted value was obtained using the first training data 35 excluding all the detected outlier data 34. In Example 2, as explained in FIGS. 13 and 14, the first predicted value was obtained using the first training data 35 with all the training data 31 except the outliers for which the first predicted values were obtained. In Examples 1 and 2, the third regression model 39 was created using the outlier-substituted training data 38, in which the value of the objective variable for the outlier was substituted with the first predicted value, and the MAPE (mean absolute percentage error) was calculated using eighty-one (81) data prepared separately from the training data 31 as test data.

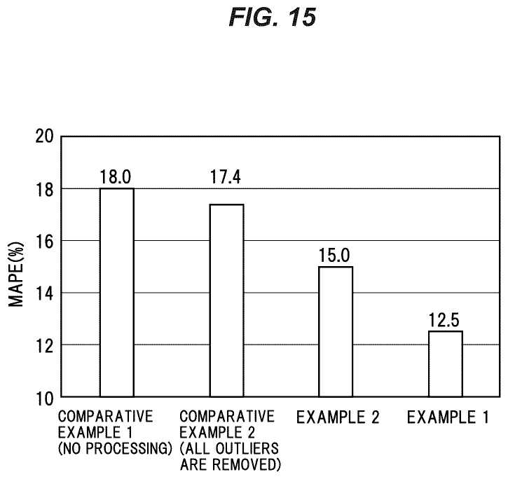

For comparison, MAPE calculations were performed in the same way as in Examples 1 and 2 for Comparative example 1 (no processing), in which the third regression model was created using the training data 31 including outliers as is, and for Comparative example 2 (all outliers removed), in which the third regression model was created using the training data from which all outliers were excluded. The results are summarized in FIG. 15.

As shown in FIG. 15, the MAPE of Comparative example 2 is lower than that of Comparative example 1, and the prediction accuracy is slightly improved by removing outliers. However, in Comparative example 2, the number of data used for learning was reduced by removing outliers, and the numerical value range that can be accurately predicted was narrower. In contrast, in Examples 1 and 2, the MAPE was reduced compared to Comparative examples 1 and 2, and it was confirmed that the prediction accuracy was improved. Furthermore, in Examples 1 and 2, the number of data has not decreased because the values of the objective variable are substituted with the first predicted value without removing outliers, and the numerical value range of the explanatory variable that can be accurately predicted is wider compared to Comparative example 2.

### Functions and Effects of the Embodiments

As explained above, in this data processing method, the first regression model 36 is created using the first training data 35 that excludes the outliers detected in the outlier detection processing as teaching data. And using the first regression model 36, the predicted value calculation processing is performed to obtain the first predicted value, which is the predicted value of the objective variable corresponding to the value of the explanatory variable for each outlier, and the outlier-substituted training data 38 is created by substituting the outliers in the training data 31 with values based on the first predicted value.

By using the first regression model 36, which excludes outliers in the predicted value calculation processing, as the teaching data, it becomes possible to accurately obtain the first predicted value, which is the predicted value of the objective variable for the value of the explanatory variable of the outlier. As a result, the prediction accuracy in the prediction processing using the outlier-substituted training data 38, in which the outlier is substituted with the first predicted value, as the teaching data can be improved (see FIG. 15). In addition, the number of data in the teaching data does not decrease because the outliers are substituted with the first predicted value without removing the outliers in the present embodiment. Therefore, according to the present embodiment, the numerical range of explanatory variables that can be accurately predicted can be suppressed from becoming narrower.

### Summary of the Embodiments

Next, the technical concepts that can be grasped from the above-described embodiments will be described with the help of the codes, etc. in the embodiments. However, each sign, etc. in the following description is not limited to the members, etc. specifically shown in the embodiments for the components in the scope of claims.

According to the first feature, a data processing method for data processing of training data 31 including a plurality of data comprising an explanatory variable and an objective variable includes: an outlier detection step of detecting an outlier from the training data 31; a predicted value calculation step of creating a first training data 35 by excluding the outlier detected in the outlier detection step from the training data 31, creating a first regression model 36 using the first training data 35 as teaching data, and using the first regression model to obtain a first predicted value, which is a predicted value of the objective variable corresponding to a value of the explanatory variable of the excluded outlier; and a data substitution step of substituting the excluded outlier with a value based on the first predicted value from the training data 31 to create outlier-substituted training data 38.

According to the second feature, in the data processing method as described in the first feature, in the predicted value calculation step, the first training data 35 is created from the training data 31 by excluding all outliers detected in the outlier detection step, the first regression model 36 is created using the first training data 35 as the teaching data, and the first predicted value corresponding to each of the excluded outliers is obtained using the first regression model 36.

According to the third feature, in the data processing method as described in the first feature, in the predicted value calculation step, for each of the outliers detected in the outlier detection step, the first training data 35 is created from the training data 31 by excluding the each data, the first regression model 36 is created using the first training data 35 as the teaching data, and the first predicted value corresponding to the each data is obtained using the first regression model 36.

According to the fourth feature, in the data processing method as described in the first feature, respective data included in the training data 31 include multiple values of the objective variable, and the outlier detection step includes a data classification step of calculating a variation coefficient of the value of the objective variable for the respective data, and classifying the respective data into outlier candidate data 32 and normal data 33 based on the calculated variation coefficient and a reference value, and an outlier determination step of creating a second regression model using the normal data 33 as teaching data, obtaining a second predicted value, which is a predicted value of the objective variable corresponding to a value of the explanatory variable of the respective data of the outlier candidate data 32, using the second regression model, and determining whether the respective data of the outlier candidate data is an outlier based on the value of the objective variable of the respective data of the outlier candidate data.

According to the fifth feature, the data processing method as described in the first feature, further includes a prediction step of creating a third regression model 39 using the outlier-substituted training data 38 as the teaching data, and using the third regression model 39 to predict a third predicted value, which is a predicted value of the objective variable corresponding to a value of the explanatory variable to be predicted.

According to the sixth feature, a data processing device for data processing of training data 31 including a plurality of data comprising an explanatory variable and an objective variable includes: an outlier detection processing unit 22 for detecting an outlier from the training data 31; a predicted value calculation processing unit 23 for creating a first training data 35 by excluding the outlier detected by the outlier detection processing unit 22 from the training data 31, creating a first regression model 36 using the first training data 35 as teaching data, and using the first regression model to obtain a first predicted value, which is a predicted value of the objective variable corresponding to a value of the explanatory variable of the excluded outlier; and a data substitution processing unit 24 for substituting the excluded outlier with a value based on the first predicted value from the training data 31 to create outlier-substituted training data 38.

### Appendix

The above description of the embodiments of the invention does not limit the invention as claimed above. It should also be noted that not all of the combinations of features described in the embodiments are essential to the means for solving the problems of the invention. In addition, the invention can be implemented with appropriate modifications to the extent that it does not depart from the gist of the invention.

1. A data processing method for data processing of training data including a plurality of data comprising an explanatory variable and an objective variable, comprising:
an outlier detection step of detecting an outlier from the training data;
a predicted value calculation step of creating a first training data by excluding the outlier detected in the outlier detection step from the training data, creating a first regression model using the first training data as teaching data, and using the first regression model to obtain a first predicted value, which is a predicted value of the objective variable corresponding to a value of the explanatory variable of the excluded outlier; and
a data substitution step of substituting the excluded outlier with a value based on the first predicted value from the training data to create outlier-substituted training data.

2. The data processing method, according to claim 1, wherein, in the predicted value calculation step, the first training data is created from the training data by excluding all outliers detected in the outlier detection step, the first regression model is created using the first training data as the teaching data, and the first predicted value corresponding to each of the excluded outliers is obtained using the first regression model.

3. The data processing method, according to claim 1, wherein, in the predicted value calculation step, for each of the outliers detected in the outlier detection step, the first training data is created from the training data by excluding the each data, the first regression model is created using the first training data as the teaching data, and the first predicted value corresponding to the each data is obtained using the first regression model.

4. The data processing method, according to claim 1, wherein respective data included in the training data include multiple values of the objective variable, and the outlier detection step includes a data classification step of calculating a variation coefficient of the value of the objective variable for the respective data, and classifying the respective data into outlier candidate data and normal data based on the calculated variation coefficient and a reference value, and an outlier determination step of creating a second regression model using the normal data as teaching data, obtaining a second predicted value, which is a predicted value of the objective variable corresponding to a value of the explanatory variable of the respective data of the outlier candidate data, using the second regression model, and determining whether the respective data of the outlier candidate data is an outlier based on the value of the objective variable of the respective data of the outlier candidate data.

5. The data processing method, according to claim 1, further comprising:
a prediction step of creating a third regression model using the outlier-substituted training data as the teaching data, and using the third regression model to predict a third predicted value, which is a predicted value of the objective variable corresponding to a value of the explanatory variable to be predicted.

6. A data processing device for data processing of training data including a plurality of data comprising an explanatory variable and an objective variable, comprising:
an outlier detection processing unit for detecting an outlier from the training data;
a predicted value calculation processing unit for creating a first training data by excluding the outlier detected by the outlier detection processing unit from the training data, creating a first regression model using the first training data as teaching data, and using the first regression model to obtain a first predicted value, which is a predicted value of the objective variable corresponding to a value of the explanatory variable of the excluded outlier; and
a data substitution processing unit for substituting the excluded outlier with a value based on the first predicted value from the training data to create outlier-substituted training data.
